(19) United States
(12) Patent Application Publication
(10) Pub. No.: US 2025/0199286 A1
(43) Pub. Date: Jun. 19, 2025

(54) PROCESS AND SYSTEMS FOR AUTOFOCUSING AND MEASURING TILT OF SAMPLE PLANE

(71) Applicant: IDEXX Laboratories, Inc., Westbrook, ME (US)

(72) Inventor: Carleton Ericson, Westbrook, ME (US)

(73) Assignee: IDEXX Laboratories, Inc., Westbrook, ME (US)

(21) Appl. No.: 18/977,033

(22) Filed: Dec. 11, 2024

Related U.S. Application Data
(60) Provisional application No. 63/610,573, filed on Dec. 15, 2023.

(51) Int. Cl. G02B 21/24; G02B 7/36; G02B 21/36

(52) U.S. Cl. CPC G02B 21/244; G02B 7/36; G02B 21/365

(57) ABSTRACT

A method for autofocusing a microscopy unit is provided that includes imaging a first field of view of a biological sample with the microscopy unit, the biological sample housed within a cartridge chamber inserted into the microscopy unit; detecting a plurality of artificial particles within the first field of view, the plurality of artificial particles dispersed within the biological sample within the cartridge chamber; and determining a focus curve for each of the plurality of artificial particles.

### CROSS-REFERENCE TO RELATED APPLICATIONS

This application claims priority to U.S. Provisional Application No. 63/610,573 filed Dec. 15, 2023, the disclosure of which is hereby incorporated by reference in its entirety.

### TECHNICAL FIELD

The present specification relates to microscopy, and more particularly, to autofocusing on a biological sample.

### BACKGROUND

Microscopy can be utilized to analyze biological samples deposited on slides utilizing a camera. The biological samples deposited onto the slides may include cells in a two-dimensional plane. Focus of the camera in a two-dimensional plane tends to yield sufficiently clear images for such two-dimensional biological samples. However, when the biological sample is a liquid housed in a container giving the sample three-dimensions, bringing the cells in focus to produce a clear image of the cells is difficult. Moreover, the bottom of the container may include imperfections such as tilted surfaces. Accordingly, a need exists for an improved method of autofocusing on cells of a biological sample housed in a container and measuring the tilt of the container to produce clearer images of the cells.

### SUMMARY

In one embodiment, a method for autofocusing a microscopy unit may include imaging a first field of view of a biological sample with the microscopy unit, the biological sample housed within a cartridge chamber inserted into the microscopy unit. The method also includes detecting a plurality of artificial particles within the first field of view, the plurality of artificial particles dispersed within the biological sample within the cartridge chamber, and determining a focus curve for each of the plurality of artificial particles.

In another embodiment, a microscopy unit includes a camera and an imaging system communicatively coupled to the camera, the imaging system including a processor and a non-transitory memory storing computer code which, when executed by the processor, cause the processor to image a first field of view of a biological sample with the microscopy unit, the biological sample housed within a cartridge chamber inserted into the microscopy unit, detect a plurality of artificial particles within the first field of view, the plurality of artificial particles dispersed within the biological sample within the cartridge chamber, and determine a focus curve for each of the plurality of artificial particles.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example imaging system for use with a microscopy unit, according to one or more embodiments shown and described herein;

FIG. 2 schematically depicts example components of a controller of the microscopy device, according to one or more embodiments shown and described herein;

FIG. 3A schematically depicts an example straight focal plane and cells on a flat surface, according to one or more embodiments shown and described herein;

FIG. 3B schematically depicts an example curved focal plane and cells on a flat surface, according to one or more embodiments shown and described herein;

FIG. 3C schematically depicts an example curved focal plane and cells on a tilted surface, according to one or more embodiments shown and described herein;

FIG. 3D schematically depicts an example curved focal plane and cells raised from a tilted surface, according to one or more embodiments shown and described herein;

FIG. 4A schematically depicts a side-view of a bottom surface of a cartridge chamber with a biological sample and solution therein, according to one or more embodiments shown and described herein;

FIG. 4B schematically depicts a side-view of a bottom surface of a cartridge chamber with a plurality of artificial particles suspended therein, according to one or more embodiments shown and described herein;

FIG. 4C schematically depicts a top-view of a cartridge chamber with a plurality of artificial particles suspended therein, according to one or more embodiments shown and described herein;

FIG. 5A schematically depicts an example of a focus area on a surface with no tilt, according to one or more embodiments shown and described herein;

FIG. 5B schematically depicts an example shifted focus area on a surface with tilt, according to one or more embodiments shown and described herein;

FIG. 6 schematically depicts a top view of an exemplary image of cells within a cartridge chamber, according to one or more embodiments shown and described herein;

FIG. 7A schematically depicts a normalized variance plotted against a surface height, according to one or more embodiments shown and described herein; and

FIG. 7B schematically depicts an offset of a bottom surface mapped on an x-y plane of the bottom surface, according to one or more embodiments shown and described herein.

### DETAILED DESCRIPTION

Imaging technology holds a prominent role in modern biological laboratories, facilitating detailed examinations of biological phenomena across various scales and levels of complexity. The emergence of digital microscopy has ushered in a new era of optical imaging, providing researchers with the means to closely monitor and analyze biological samples with unprecedented precision in terms of resolution, specificity, dimensionality, and scale. Within the realm of digital microscopy, cells may be dispersed within a liquid such that the cells are housed within a cartridge holding a three-dimensional volume of fluid, rather than on a slide holding cells on a two-dimensional plane. A foundational concern when imaging cells held in a three-dimensional volume is inconsistency in the appearance of cells and/or unusable out-of-focus images.

In practice, a focus of a camera is moved up or down to focus on cells within the fluidic biological sample housed within a cartridge. However, cells within the biological sample may be blurry or out-of-focus. This may be due to imperfections on a bottom surface of the cartridge, optical field curvature, or biological diversity within the sample. For example, the bottom surface of the cartridge may include a tilt at one or multiple points on the bottom surface. As such, cells settled on the bottom surface at those tilted portions of the bottom surface may appear blurry or out of focus when images are captured by the camera.

To enhance reliability of images captured through microscopy, it is desirable to enhance the image quality of the biological sample. The systems and methods disclosed herein utilize artificial particles, such as quality control (QC) beads to focus an imaging sensor and, thus, produce clearer images. The systems and methods image the biological sample, and the artificial particles serve as a reference as to where the bottom surface of the cartridge is located in the z-direction. The systems and methods may autofocus the imaging sensor based on locations of the artificial particles in the z-direction. As such, a greater portion of or all of the cells located at the bottom surface of the cartridge may be clear/in-focus.

Systems and methods disclosed herein are used for biological sample imaging using artificial particles as references. The system includes a microscopy unit, a diluent comprising fluorescent dyes, a sample holder, and a plurality of artificial particles. The artificial particles and the biological sample are mixed with a diluent in the sample holder to form a solution. The biological sample is imaged with the artificial particle as reference markers using the microscopy unit. The settling time of the artificial particles is shorter than or equal to the settling time of the biological sample.

Directional terms as used herein—for example x-direction, y-direction, z-direction, up, down, right, left, front, back, top, bottom—are made only with reference to the figures as drawn and are not intended to imply absolute orientation.

Solutions described herein may include a biological sample and a liquid diluent. The liquid diluent may be, without limitations, water-based, phosphate-buffered saline (PBS), or any diluent with a specific function used to provide a desirable environment for biological imaging, such as a balanced pH range to maintain the viability of the biological samples.

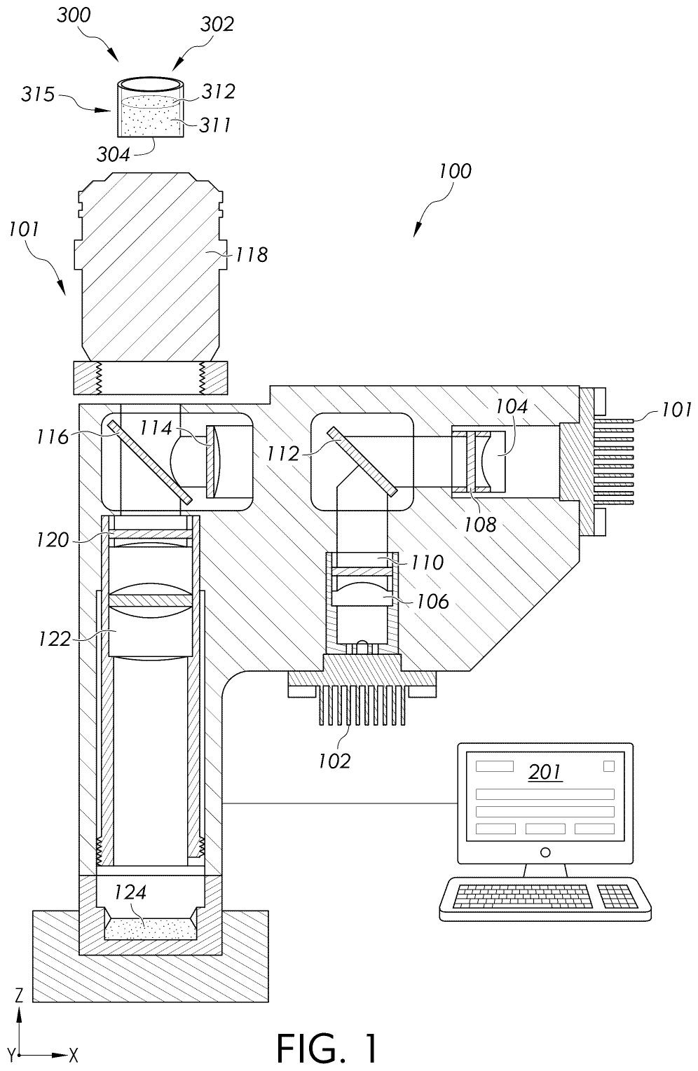

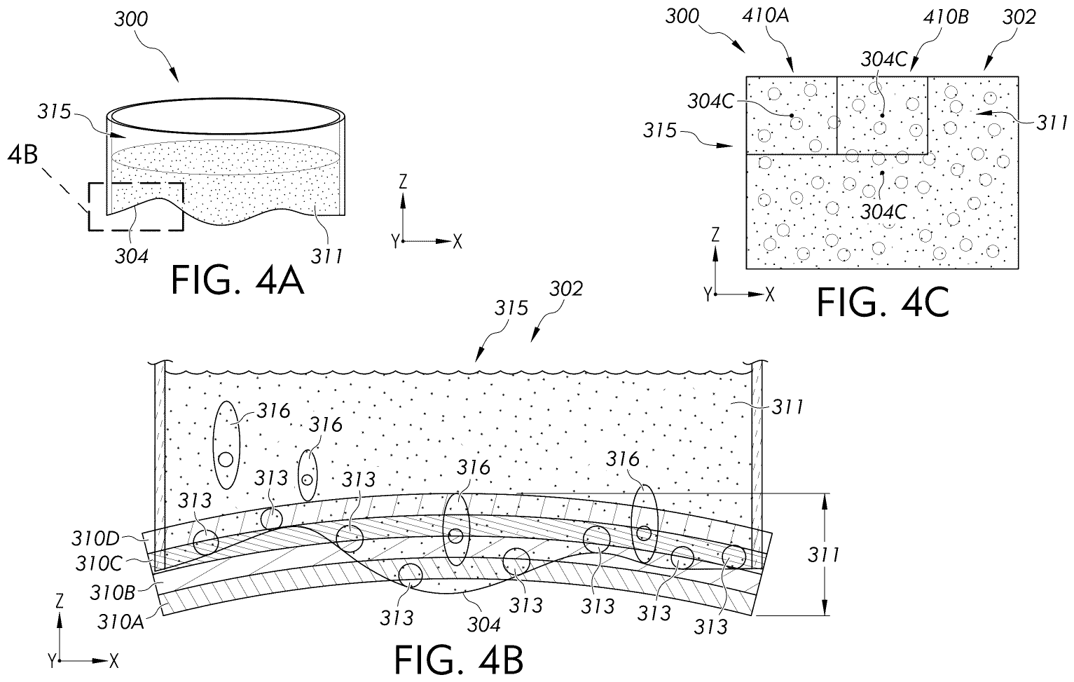

Referring now to FIG. 1, a microscopy system 100 includes a microscopy unit 101. The microscopy unit 101 may include an imaging sensor 124 and an imaging system 201, which may be communicatively coupled to each other through one or more connections. In embodiments a cartridge 300 with a cartridge chamber 302 and a bottom surface 304 can be positioned on or within the microscopy system 100. A biological sample 315 may be positioned at least partially within the cartridge chamber 302. As noted herein, the biological sample 315 may include biological cells 316 and be part of a solution 311 (e.g., as illustrated in FIGS. 4A and 4B). In embodiments, the solution 311 may include a diluent 312 and a plurality of artificial particles 313. The biological sample can be any suitable sample for microscopic interrogation, such as without limitation, blood, fine needle aspirate (FNA), fecal sample, ear swabs or the like. In embodiments, the artificial particles 313 may be a synthetic material or the like having known properties. For example, the artificial particles may have known dimensions, shapes, densities or the like. Because the artificial particles 313 have known properties, the position of the artificial particles 313 within the cartridge 300 can be utilized to determine focus of the microscopy system 100, determine a tilt level of the cartridge 300 within the microscopy system 100, or map the bottom surface 304 of the cartridge chamber 302.

Images of the biological sample 315 and artificial particles 313 within the cartridge chamber 302 may be captured by the imaging sensor 124. As depicted in FIG. 1, the imaging sensor 124 may be below the cartridge chamber 302, such that the imaging sensor 124 captures images of the solution 311 through the bottom surface 304 of the cartridge chamber 302 (i.e., the microscopy unit 101 is an inverted microscope). However, it should be understood that the imaging sensor 124 may be above the cartridge chamber 302, such that the imaging sensor 124 captures images of the biological sample 315 and artificial particles 313 through the top of the cartridge 300 (i.e., the microscopy unit 101 is an upright microscope).

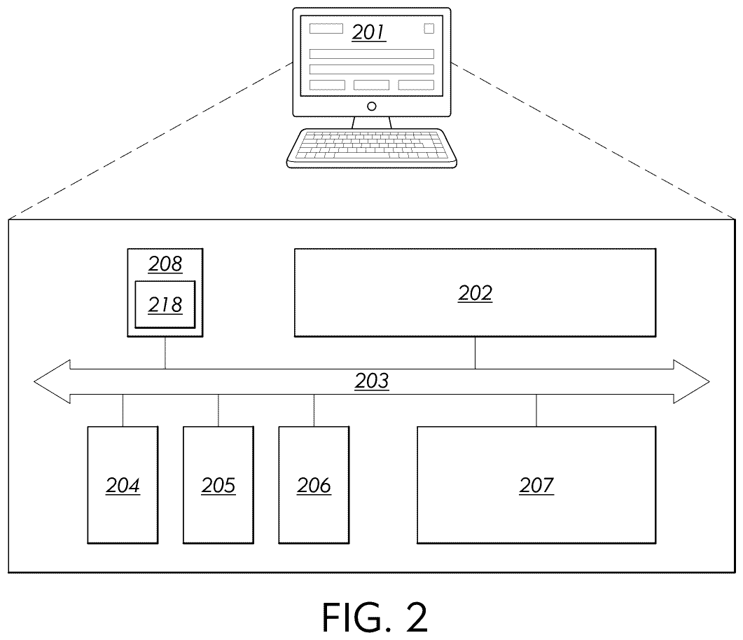

The microscopy system 100 may include the imaging system 201, as shown in FIG. 2. The imaging system 201 includes an input/output interface 205 and the one or more connections to communicatively couple the imaging system 201 to the microscopy unit 101. The one or more connections connect components of the microscopy system 100 to the imaging system 201 and allow signal transmission between the components of the microscopy system 100. The connections may be formed from any medium that is capable of transmitting a signal such as, for example and without limitation, conductive wires, conductive traces, optical waveguides, or the like. In some embodiments, the connections may facilitate the transmission of wireless signals, such as WiFi, Bluetooth®, Near Field Communication (NFC) and the like. Moreover, the connections may be formed from a combination of mediums capable of transmitting signals. In one embodiment, the connections may include a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The imaging system 201 may receive inputs from the components and provide outputs to the components of the microscopy unit 101. While in the embodiment depicted in FIG. 1 the imaging system 201 is depicted as being separate from the microscopy unit 101, it should be understood that this is merely an example. In some embodiments, the imaging system 201 and the microscopy unit 101 are housed in a single device.

The microscopy system 100 depicted in FIG. 1 includes the microscopy unit 101. The microscopy unit 101 is, without limitations, an optical microscopy device, a light microscopy device, an electron microscopy device, a confocal microscopy device, a multiphoton microscopy device, or a fluorescence microscopy device. In some embodiments, the microscopy unit 101 is a digital microscope. The microscopy unit 101 may include, without limitations, one or more light sources, one or more lenses (such as, without limitations, a condenser lens and an objective lens), one or more mirrors and filters, one or more specimen stages, such as a well or a chamber, and any components and parts suitable for the operation of the microscopy unit 101.

As illustrated in FIG. 1, the microscopy unit 101 may include, without limitation, one or more light sources, including, without limitation, brightfield sources and/or fluorescence light sources of various wavelengths (such as a fluorescent blue light source 601 and a fluorescent ultraviolet light source 102, and/or a brightfield light source), collector lenses 104 and 106, a blue excitation filter 108, an ultraviolet excitation filter 110, an excitation dichroic 112, a field lens 114, an imaging dichroic mirror 116, an objective lens 118, a triband filter 120, a tube lens 122, and the imaging sensor 124.

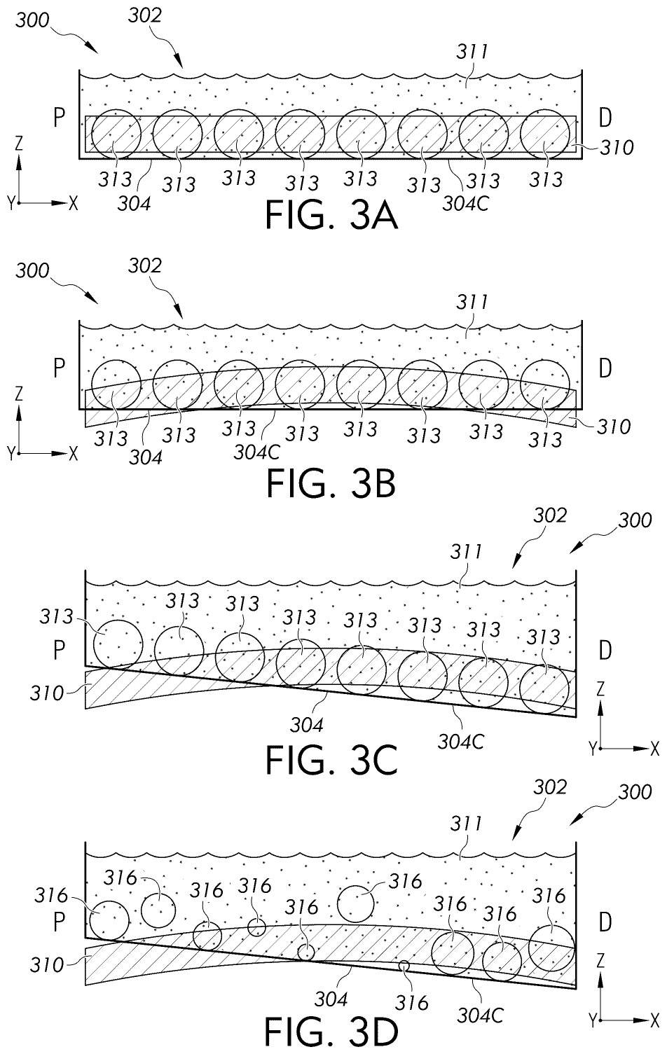

In operation, the cartridge chamber 302 may be inserted into the microscopy unit 101, such as through an opening into a well or chamber of the microscopy unit 101 such that the solution 311 is placed along the path of the fluorescent blue light source 601, the fluorescent ultraviolet light source 102, and/or the brightfield light source. In particular, the biological sample 315 may be analyzed by the microscopy unit 101, such that the results from the microscopy unit 101 may be used to analyze the biological sample 315. One of the light sources, such as the fluorescent blue light source 601, the fluorescent ultraviolet light source 102, and/or the brightfield light source, illuminates the biological samples 315 or the plurality of artificial particles 313 (as depicted in FIGS. 3A-3D). An image or images of the biological samples 315 and/or the plurality of artificial particles 313 is captured by the imaging sensor 124.

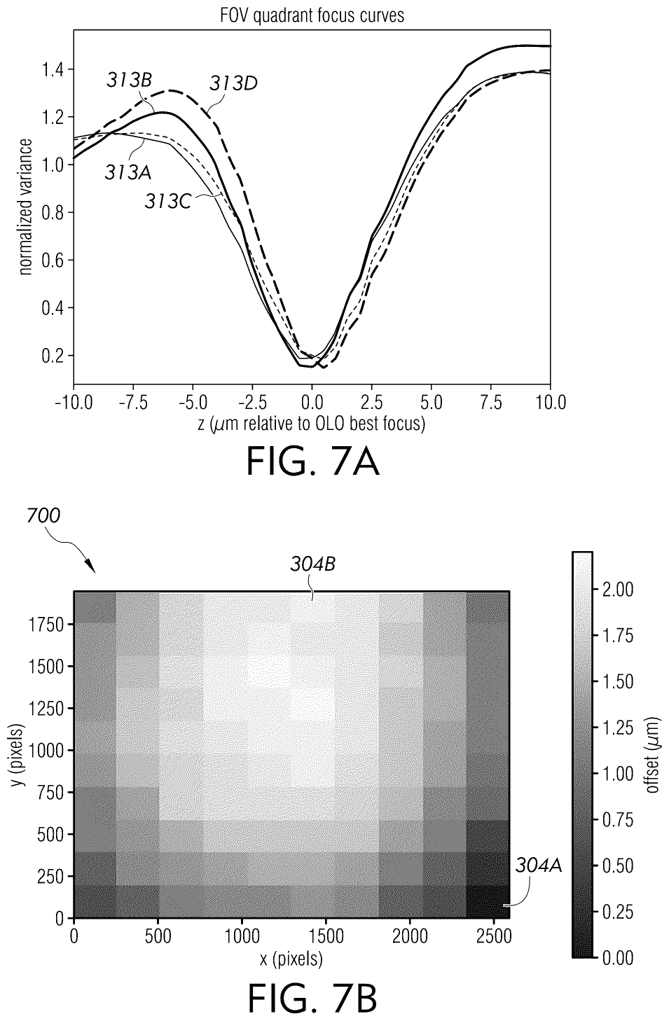

The image captured by the imaging sensor 124 may be transmitted to the imaging system 201 for automated analysis. An image and additional information may be displayed at a display 208 including a user interface 218 (FIG. 2). The microscopy unit 101 may utilize one or more microscopy techniques to determine attributes associated with sample preparation and biological analysis process. In the illustrated example, the attributes may be used to determine, without limitations, the settlement of the biological samples 315, a tilt level of the cartridge chamber 302, a three-dimensional model 700 (FIG. 7) of the bottom surface 304 of the cartridge chamber 302, or an optimum focus level for the imaging sensor 124. However, in other examples, the microscopy unit 101 may identify other attributes.

Referring to FIG. 2, exemplary non-limiting components of the microscopy system 100 are depicted. The imaging system 201 may include various components, such as a memory component 202, a processor 204, an input/output interface 205, a network interface hardware 206, a data storage component 207, the display 208 including the user interface 218, and a local interface 203. The imaging system 201 may include one or more displays 208 with one or more user interfaces 218.

The imaging system 201 may be any device or combination of components comprising the processor 204 and the memory component 202, such as a non-transitory computer readable memory. The processor 204 may be any device capable of executing the machine-readable instruction set stored in the non-transitory computer readable memory. Accordingly, the processor 204 may be an electric controller, an integrated circuit, a microchip, a computer, or any other computing device. The processor 204 may include any processing component(s) configured to receive and execute programming instructions (such as from the data storage component 207 and/or the memory component 202). The instructions may be in the form of a machine-readable instruction set stored in the data storage component 207 and/or the memory component 202. The processor 204 is communicatively coupled to the other components of the imaging system 201 by the local interface 203. Accordingly, the local interface 203 may communicatively couple any number of processors 204 with one another, and allow the components coupled to the local interface 203 to operate in a distributed computing environment. The local interface 203 may be implemented as a bus or other interface to facilitate communication among the components of the imaging system 201. While the embodiment depicted in FIG. 2 includes a single processor, other embodiments may include more than one processor.

The memory component 202 (e.g., a non-transitory computer-readable memory component) may include RAM, ROM, flash memories, hard drives, or any non-transitory memory device capable of storing machine-readable instructions such that the machine-readable instructions can be accessed and executed by the processor 204. The machine-readable instruction set may include logic or algorithm(s) written in any programming language of any generation (e.g., 1GL, 2GL, 3GL, 4GL, or 5GL) such as, for example, machine language that may be directly executed by the processor 204, or assembly language, object-oriented programming (OOP), scripting languages, microcode, etc., that may be compiled or assembled into machine readable instructions and stored in the memory component 202. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. For example, the memory component 202 may be a machine-readable memory (which may also be referred to as a non-transitory processor-readable memory or medium) that stores instructions that, when executed by the processor 204, causes the processor 204 to perform a method or control scheme as described herein. While the embodiment depicted in FIG. 2 includes a single non-transitory computer-readable memory component, other embodiments may include more than one memory module. The memory component 202 may be used to store the one or more modules. The one or more modules during operating may be in the form of operating systems, application program modules, and other program modules. Such program modules may include, but are not limited to, routines, subroutines, programs, objects, components, and data structures for performing specific tasks or executing specific abstract data types according to the present disclosure as will be described below.

The input/output interface 205 may include a monitor, keyboard, mouse, printer, camera, microphone, speaker, and/or other device for receiving, sending, and/or presenting data. The network interface hardware 206 may include any wired or wireless networking hardware, such as a modem, LAN port, Wi-Fi card, WiMax card, mobile communications hardware, and/or other hardware for communicating with other networks and/or devices. The data storage component 207 may store the one or more modules. The input/output interface 205 and the network interface hardware 206 allow a user to send input to the imaging system 201 of the microscopy system 100 to control and manipulate the components of the microscopy system 100, such as the fluorescent blue light source 601, the fluorescent ultraviolet light source 102, the brightfield light source, the collector lenses 104 and 106, the blue excitation filter 108, the ultraviolet excitation filter 110, the excitation dichroic 112, the field lens 114, the imaging dichroic mirror 116, the objective lens 118, the triband filter 120, the tube lens 122, and the imaging sensor 124, and receive output from the imaging system 201.

In operation, the imaging sensor 124 may capture image data and communicate the image data to the processor 204. The image data may be received by the processor 204, which may process the image data using one or more image processing algorithms. Any known or yet-to-be developed video and image processing algorithms may be applied to the image data in order to identify an item or situation. Example video and image processing algorithms include, but are not limited to, kernel-based tracking (such as, for example, mean-shift tracking) and contour processing algorithms. In general, video and image processing algorithms may detect objects and movement from sequential or individual frames of image data. One or more object recognition algorithms may be applied to the image data to extract objects and determine their relative locations to each other. Any known or yet-to-be-developed object recognition algorithms may be used to extract the objects or even optical characters and images from the image data. Example object recognition algorithms include, but are not limited to, scale-invariant feature transform (“SIFT”), speeded up robust features (“SURF”), and edge-detection algorithms.

The data storage component 207 stores collected imaging data and data of operating various components of the microscopy unit 101. The various modules may also be stored in the data storage component 207 during operating or after operation.

In embodiments that include the display 208, the display 208 includes the user interface 218, a screen, one or more devices in communication with the processor 204 (such as smartphones, tables, and the like), and/or any other device or interface suitable for displaying data. In some examples, the display 208 is a touchscreen and may be configured as an input device to receive user input.

Each of the various modules may include one or more machine learning algorithms or neural networks. Each module may be trained and provided machine learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling. The one or more ANN models may employ a combination of artificial intelligence techniques, such as, but not limited to, Deep Learning, Random Forest Classifiers, Feature extraction from audio, images, clustering algorithms, or combinations thereof. In some embodiments, a convolutional neural network (CNN) may be utilized. For example, a CNN may be used as an ANN that, in a field of machine learning, for example, is a class of deep, feed-forward ANNs applied for audio analysis of the recordings. CNNs may be shift or space invariant and utilize shared-weight architecture and translation. Further, each of the various modules may include generative artificial intelligence algorithms. The generative artificial intelligence algorithm may include a general adversarial network (GAN) that has two networks, a generator model and a discriminator model. The generative artificial intelligence algorithm may also be based on variation autoencoder (VAE) or transformer-based models.

In some embodiments, the imaging system 201 may connect to a server or other systems, such as Internet of Things (IoTs) through the network interface hardware 206 to send acquired imaging data for further analysis and receive recommendations for further operation of the system 100. The system 100 may monitor the operation of the microscopy unit 101 including the focusing performance and acquired image data and transfer real-time and/or recorded data (such as videos, images, messages, status, warning, and instructions, etc.) to a server or a user via wired or wireless connections, such as, without limitations, a cellular connection, internet, and any radio-wave based communication.

Referring to FIGS. 3A-3D, exemplary focal planes 310 are depicted. The shaded band represents a focal plane 310 of the imaging sensor 124. The focal plane 310 of the imaging sensor 124 represents areas that are in focus, while areas that are not within the focal plane 310 are out of focus of the imaging sensor 124. FIG. 3A depicts all artificial particles 313 of the solution 311 settled at the bottom of the bottom surface 304 of the cartridge chamber 302. As depicted in FIG. 3A, all of the artificial particles 313 are within the focal plane 310 (i.e., in focus) of the imaging sensor 124. The focal plane 310 of the imaging sensor 124 is determined by a depth of field of the imaging sensor 124, which may be 0.5 microns deep+/−10%, 1 micron deep+/−10%, 1.5 microns deep+/−10%, 2 microns deep+/−10%, 2.5 microns deep+/−10%, 3 microns deep+/−10%, 4 microns deep+/−10%, 5 microns deep+/−10%, 7 microns deep+/−10%, 10 microns deep+/−10%, or any other suitable depth.

It should be noted that the focal plane 310 of FIG. 3A is flat with respect to the z-direction (e.g., the direction that the imaging sensor 124 is pointed), which is a desired scenario, however in practice most cameras 124 will include a curved focal plane 310 with respect to the z-direction, as depicted in FIG. 3B. As depicted in FIG. 3B, the focal plane 310 is curved and each of the artificial particles 313 are at least partially in focus. However, the artificial particles 313 that are closest to a center 304c of the bottom surface 304 are more in focus when compared to those artificial particles 313 closest to a proximal end P and a distal end D of the bottom surface 304. Thus, images of the artificial particles 313 closest to the center 304c of the bottom surface 304 will be clearest in the images captured by the imaging sensor 124, while the biological cells 316 furthest from the center 304c (i.e., closest to the proximal end P and distal end D) of the bottom surface 304 may be somewhat blurry in the images captured by the imaging sensor 124.

FIG. 3C depicts the curved focal plane 310 of the imaging sensor 124 with a tilted bottom surface 304 of the cartridge chamber 302. The artificial particles 313 near the center 304c of the bottom surface 304 and closest to the distal end D of the bottom surface 304 are nearly entirely within the focal plane 310 and, thus, clear images of such artificial particles 313 will be produced in images captured by the imaging sensor 124. On the other hand, artificial particles 313 nearest the proximal end P of the bottom surface 304 are almost entirely out of the focal plane 310 and thus, unclear/blurry images of such biological cells 316 will be produced in images captured by the imaging sensor 124. As discussed further herein, the artificial particles 313 may be out of focus due to a tilted bottom surface 304 of the cartridge chamber 302. Moreover, the biological cells 315 may be out of focus when biological cells 316 vary in shape/size and do not settle to the bottom surface 304 of the cartridge chamber 302. For example, as depicted in FIG. 3D, biological cells 316 of various sizes have not settled to the bottom surface 304 of the cartridge chamber 302. This may result in some of the biological cells 316 being in or out of focus.

As depicted in FIGS. 3A-3D, tilt at the bottom surface 304 of the cartridge chamber 302 and biological cells 316 of the biological sample 315 not settling at the bottom surface 304 of the cartridge chamber 302 may result in a focal plane 310 that does not produce clear images of the artificial particles 313 and/or biological cells 316. The focus of the imaging sensor 124 may be adjusted to control the focal plane 310 in the z-direction and, thus, produce clearer images captured by the imaging sensor 124. The focus of the imaging sensor 124 may be adjusted to capture the bottom surface 304 of the cartridge chamber 302.

To focus the imaging sensor 124 such that more of the focal plane 310 is on the bottom surface 304 of the cartridge chamber 302, artificial particles 313 may be placed into the solution 311 that fall to the bottom surface 304 of the cartridge chamber 302. In embodiments, a focus curve for each of the artificial particles 313 may be determined (described further herein). As such, a tilt level of the bottom surface 304 of the cartridge may be determined through the z-position of each of the artificial particles 313. However, the tilt level at the bottom surface 304 may be different for various fields of view of the imaging sensor 124. The imaging sensor 124 may be autofocused for different fields of view using the systems and methods described herein.

FIG. 4A is a side view of the cartridge chamber 302 with the biological sample 315 and the solution 311 therein. FIG. 4B is an enlarged view of the bottom surface 304 of the cartridge chamber 302. Specifically, FIG. 4B is a side view of the cartridge chamber 302 with the solution 311 containing the artificial particles 313 settled at the bottom surface 304 of the cartridge chamber 302. FIG. 4C is a top view of the cartridge chamber 302 housing the solution 311 containing the artificial particles 313.

FIG. 4C further depicts a first field of view 410A and a second field of view 410B. The imaging sensor 124 may only capture one field of view 410 at a time of varying dimensions depending on a lens size or lens type of the imaging sensor 124. As such, the imaging sensor 124 may capture images of multiple different fields of view 410 to capture images of an entirety of the bottom surface 304 of the cartridge chamber 302.

It is noted that the center 304c of the bottom surface 304 may be different for each field of view 410 than it is for the center 304c of the entirety of the bottom surface 302 of the cartridge chamber 304. It is also be noted that although there are two fields of view 410 depicted in FIG. 4C, it should be understood that any number of fields of view 410 may be captured by the imaging sensor 124. The fields of view 410 may be of any shape or size. There may be as little as one field of view 410 for the cartridge chamber 302 or as many as 1,000, 10,000, 100,000, or more fields of view for a given cartridge chamber 302. The number of fields of view 410 to capture the entirety of the bottom surface 304 of the cartridge chamber 302 may depend on the lens of the imaging sensor 124, dimensions of the cartridge chamber 302, or a distance of the imaging sensor 124 to the cartridge chamber 302.

A method for autofocusing the microscopy unit 101 may include imaging a first field of view 410A of the biological sample 315. As noted herein, the biological sample 315 may be housed within the cartridge chamber 302 and the cartridge chamber 302 may be inserted into the microscopy unit 101. The biological sample 315 may be dispersed within the solution 311 that also includes the artificial particles 313. Thus, the method may further include detecting the artificial particles 313 within the first field of view 410A. The method may also include determining a focus curve for each of the artificial particles 313.

In embodiments, focus curves for each of the artificial particles 313 may be determined in a single depth of field of the focal plane 310. As such, all of the artificial particles 313 may be within the first field of view 410A in the single focal plane 310. This may occur when the bottom surface 304 of the cartridge chamber 302 is oriented at an angle relative to horizontal and/or imperfections are formed within the bottom surface 304. It should be noted that the curvature/imperfections at the bottom surface 304 of the cartridge chamber 302 in FIGS. 4A and 4B are for illustrative purposes and are exaggerated as depicted herein.

A focus curve may include the z-position of the artificial particle 313 where the imaging sensor 124 captures a clearest image of the artificial particle 313. A “clear image” may be an image of the artificial particle 313 where the contrast of the artificial particle 313 is greatest in the image (i.e., a peak of the focus curve, as described herein). The method may also include determining a focus for the first field of view 410A, based at least in part on the focus curve for each of the artificial particles 313. The focus of the imaging sensor 124 may be at a z-position in which the artificial particles 313 are most in focus, given the focal plane 310 of the imaging sensor

For example, the single depth of field of the focal plane 310 may be greater than 4 microns deep. A single depth of field, such as one that produces the first focal plane 310A, may capture each of the artificial particles 313 because z-positions of the artificial particles 313 on the bottom surface 304 of the cartridge chamber 302 do not vary by more than 4 microns. As such, the focus curves for each of the artificial particles 313 may be determined based on the single depth of field within the first field of view 410A. The focus for the imaging sensor 124 may then be determined based on the focus curves for each of the artificial particles 313 in the first field of view 410A.

As depicted in FIG. 4B, the first focal plane 310A may not capture each of the artificial particles 313 due to an uneven surface of the bottom surface 304 of the cartridge chamber 302 and the limited depth of field of the focal plane 310 of the imaging sensor 124, such as when the z-positions of the artificial particles 313 are greater than the single depth of field of the imaging sensor 124. Subsequent depths of field of focal planes 310 may be needed to determine a focus curve for each of the artificial particles 313 within the first field of view 410A.

A focus in the first field of view 410A may be different than a focus in the second field of view 410B, as the bottom surface 304 of the cartridge chamber 302 may be tilted differently in the first field of view 410A and the second field of view 410B. Thus, the method for autofocusing the microscopy unit 101 may include determining a focus curve for each of the artificial particles 313 in at least one subsequent field of view. As depicted in FIG. 4C, a second field of view 410B of the imaging sensor 124 may be imaged. The focus curve for each of the artificial particles 313 in a second field of view 410B may be determined. The focus of the imaging sensor 124 may be the same or different in the first field of view 410A, the second field of view 410B, or any number of subsequent fields of view.

As noted hereinabove, FIG. 4B depicts a first focal plane 310A, a second focal plane 310B, a third focal plane 310C, and a fourth focal plane 310D. The biological sample 315 may contain biological cells 316 of varying sizes/shapes. As such, the biological cells 316 may be offset from the bottom surface 304 of the cartridge chamber 302. Therefore, the second focal plane 310B (or any other subsequent focal plane 310) may be offset from the bottom surface 304 of the cartridge chamber 302 to capture the biological cells 316 of the biological sample 315. Focus curves may also be determined for the biological cells 316 of the biological sample 315 when the biological cells 316 are captured within the second focal plane 310B, or any other subsequent depth of field, for the first field of view 410A, second field of view 410B, or any number of subsequent fields of view. Although four focal planes are depicted in FIG. 4B, it should be understood that any number of subsequent depth of fields of view may be imaged and are contemplated herein. Multiple focal planes 310 may be combined to capture images, such that a depth scan 311 (or z-stack) is from 1 millimeter to 50 millimeters in the z-direction. As described herein, the depth scan 311 may be multiple images taken at various z-positions (i.e., multiple focal planes 310) combined to generate focus curves. In embodiments, the depths of fields of the focal planes 310 may overlap, such that each focal plane 310 is moved up 0.5 microns, 1.0 microns, 2.0 microns, or 3.0 microns in the z-direction. In other embodiments, the focal planes 310 may be immediately on top of one another in the z-direction, as depicted in FIG. 4B.

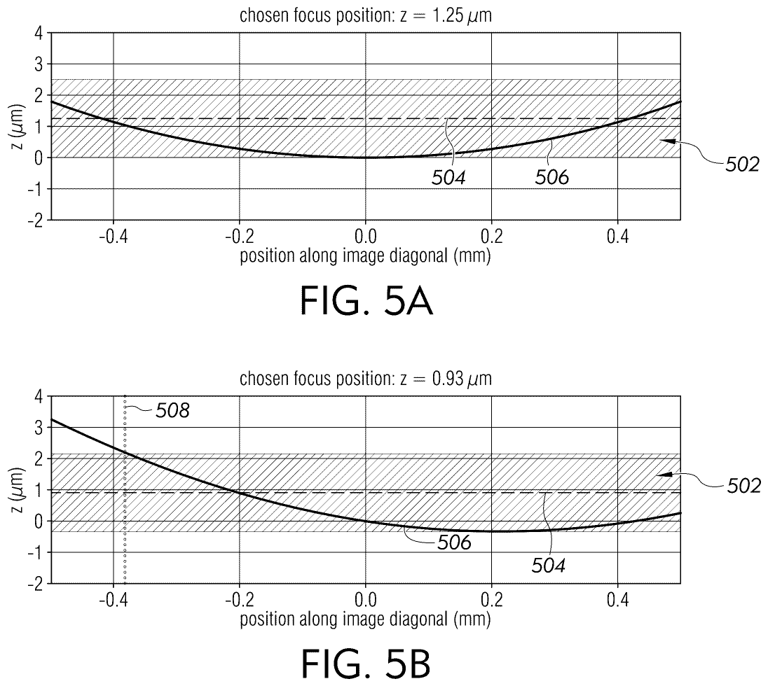

Although the focal plane 310 may have the depth of field, a focus window 502 (depicted in FIG. 5A and FIG. 5B) in which objects are acceptably in focus may be smaller than the depth of the depth of field due to movements of equipment or other sources of error in the imaging system 201. For example, the depth of field for a focal plane 310 may be 4 microns deep. However, there may be some objects within the focal plane 310 that are not acceptably in focus due to sources of error within the imaging system 201. The focus window 502 in which objects are acceptably in focus may be 1 micron+/−10%, 1.5 microns+/−10%, 2 microns+/−10%, 2.5 microns+/−10%, 3 microns+/−10%, or any other suitable window. The window may be determined by a window within the focal plane 310 that objects (such as the artificial particles 313 and the biological cells 316) have a certain contrast.

As noted herein, the focus of the imaging sensor 124 may be determined based on the focus curve for each of the artificial particles 313 for each of the fields of view 410. The focus of the imaging sensor 124 may be expressed as a focus position 504, which is a center of the focus window 502 in the z-direction with respect to the bottom surface 304 of the cartridge chamber 302 at the center 304c of the bottom surface 304, as depicted in FIG. 4C.

In some embodiments, a composite image of the cartridge 300 is created from the fields of view 410. For example, in some embodiments, a focus curve for the artificial particles 313 is determined for each of the fields of view 410, or for discrete segments of each of the fields of view 410. Images of the fields of view 410 or discrete segments of the fields of view at the different focus curves may be assembled into a single image for analysis. Analysis may include any suitable microscopic interrogation based on the sample type, such as a determination of cellular characteristics. For example, in embodiments in which blood is interrogated, cells may be classified by cell type (e.g., red blood cells, white blood cells, epithelial cells, round cells, inflammatory cells, and the like), and the number of cell types in the sample may be counted. In some embodiments, attributes of the cell types (e.g., size, etc.) may be quantified. In some embodiments, morphologic analysis is performed. For example, in embodiments, the analysis depends on the diagnostic objective and the types of structures being analyzed. Some examples of common classifications in medical diagnostics include:
Normal vs. abnormal cells: The model distinguishes between normal cells and cells exhibiting abnormal morphology, such as cancerous or diseased cells. This classification helps identify potential pathological conditions.
Morphologic cell assessment:
   Detection of overall presentation of cell; and
   Detection of cell objects and features, such as nuclear features, vacuoles, organisms, inclusions, and the like.
Cell type identification: The model classifies cells into different cell types based on their morphology and/or size. For example, in blood cell analysis, the model can classify red blood cells, white blood cells, and platelets.
Subcellular component identification: The model identifies and classifies specific subcellular components or organelles within cells. This can include classifying nucleus, cytoplasm, mitochondria, or other cellular structures.
Differentiation of cell stages: The model determines the stage or maturation level of cells.
Parasite detection: The model detects eggs, ova, parasites, bacteria, or the like in a sample, such as an ear swab sample or fecal sample.
Disease-specific classification: The model classifies cells based on specific diseases or conditions. For example, in histopathology, the model can classify cells based on different types of cancer.

In some instances, an acceptable focus curve may not be able to be determined for a field of view 410 or a discrete portion of a field of view 410 of the cartridge 300. For example, in some instances, the cartridge 300 may be tilted to such a degree that one or more fields of view 410 or discrete portions of fields of view 410 cannot be determined to adequately interrogate the biological cells 311. However, in such instances, other fields of view 410 or discrete portions of fields of view 410 can be viable for interrogation. For example, in some configurations, a 0.2° tilt of the cartridge may result in 90% of the cartridge 300 being in focus, with 10% of the cartridge (i.e., fields of view 410 or discrete portions of the fields of view 410) being unable to determine an acceptable focus curve. In such instances, according to embodiments of the present disclosure, the fields of view 410 that are in focus can be utilized to estimate features in the fields of view 410 or discrete portions of the fields of view 410 that do not have an acceptable focus curve. For example, cell counts present in the out of focus fields of view 410 (or discrete portions of fields of view 410) can be estimated utilizing the fields of view 410 that have acceptable focus curves. In this way, even when the cartridge 300 is tilted such that portions of the cartridge 300 do not fall within acceptable focus curves, attributes of the biological sample 315 can still be reported.

FIG. 5A and FIG. 5B depict the focus window 502 and the focus position 504. The focus window 502 in FIG. 5A and FIG. 5B is 2.5 microns. Also depicted is the curvature-tilt model 506. The curvature-tilt model 506 represents the amount of offset in the z-direction between the bottom surface 304 of the cartridge chamber 302 and the focal plane 310. The curvature-tilt model 506 may be modeled with a quadratic function, such as the following Equation 1:

$$Δ z ( x , y ) = c ( {x}^{2} + {y}^{2} ) + {t}_{x} x + {t}_{y} y \qquad EQU . 1$$

In Equation 1, Δz (x,y) is the curvature-tilt model 506 of the bottom surface 304 as a function of the x and y-positions of the bottom surface 304 of the cartridge chamber 302 within the field of view 410. Moreover, c is a constant curvature value, x and y represent a position on the bottom surface 304 of the cartridge chamber 302 relative to the center 304_{C} of the bottom surface 304 within the field of view 410. Moreover, tₓ and t_{y} represent the tilt/slope of the bottom surface 304 in the x and y-directions.

FIG. 5A depicts a representation of the focus window 502 with respect to the curvature-tilt model 506 when the bottom surface 304 has no tilt. The focus window 502 is flat in FIG. 5A since the curvature of the field of view 410 is built into the curvature-tilt model 506, as described in Equation 1 above.

Determining where the microscopy unit 101 is to focus and, thus, where focus window 502 should be placed may be determined by shifting the focus position 504 up from a bottom of the curvature-tilt model 506 (i.e., the smallest value of the quadratic of Equation 1) by one half of the focus window 502. In the example provided in FIG. 5A, the focus window is 2.5 microns and the bottom of the curvature-tilt model 506 is zero since there is no tilt on the bottom surface 304 of the cartridge chamber 302. Thus, the focus position 504 is at 1.25 microns (half of the 2.5 micron focus window added to the bottom of the curvature-tilt model 506).

An entirety of the curvature-tilt model 506 is captured within the focus window 502 of the imaging sensor 124 in FIG. 5A. However, if the bottom surface 304 of the cartridge chamber 302 is tilted within the field of view 410, some of the curvature-tilt model 506 may not be captured within the focus window 502 of the imaging sensor 124. As depicted in FIG. 5B, the bottom of the curvature-tilt model 506 is below zero; the bottom of the curvature-tilt model 506 is −0.32 microns. Thus, the focus position 504 is 0.93 microns (half of the focus window 502 added to the bottom of the curvature-tilt model 506). The focus window 502 may not capture all of the curvature-tilt model 506; for example, as depicted in FIG. 5B, there may be a focus mask boundary 508, outside of which the curvature-tilt model 506 is not captured. In embodiments, the curvature-tilt model 506 may be utilized to determine discrete portions of fields of view 410 that are outside of the focus window 502 of the imaging sensor 124, such as the portion of the curvature-tilt model 506 outside of the focus mask boundary 508, depicted as left of the focus mask boundary 508 in FIG. 5B.

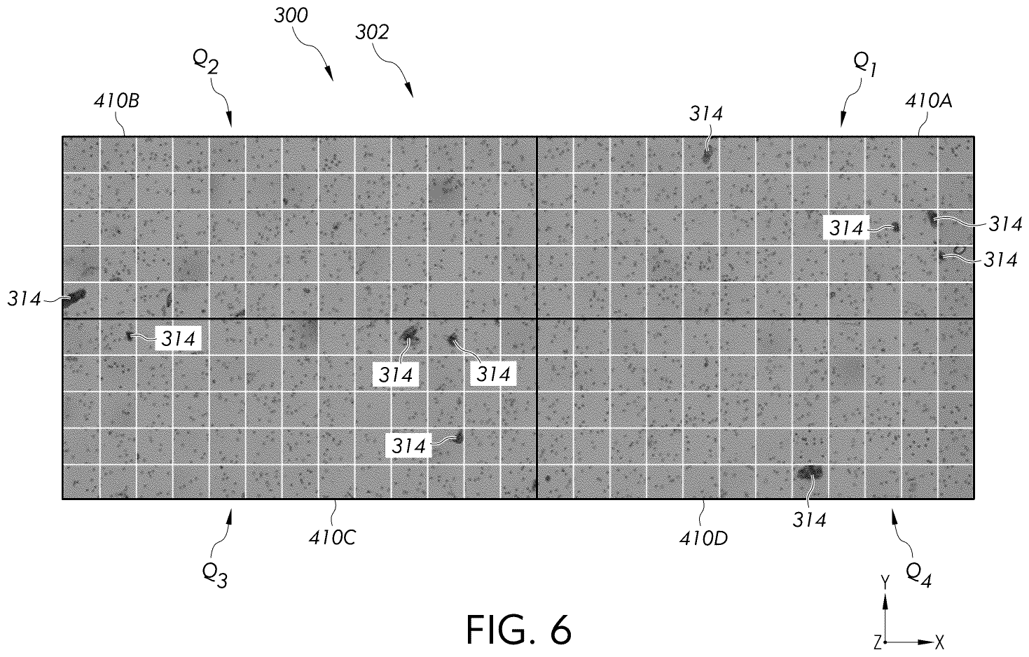

Setting the focus position 504 in accordance with the systems and methods described herein maximizes the fraction of the bottom surface 304 within the focus window 502, which results in clearer images captured by the imaging sensor 124. For example, FIG. 6 depicts an image taken by the imaging sensor 124 utilizing the systems and methods described herein. In embodiments, as depicted in FIG. 6, out of focus particles 314 may be less than or equal to 30% of the total number of artificial particles 313, less than or equal to 20% of the total number artificial particles 313, less than or equal to 15% of the total number of artificial particles 313, less than or equal to 13% of the total number of artificial particles 313, less than or equal to 10% of the total number of artificial particles 313, less than or equal to 8% of the total number of artificial particles 313, less than or equal to 7% of the total number of artificial particles 313, less than or equal to 6% of the total number of artificial particles 313, less than or equal to 5% of the total number of artificial particles 313, less than or equal to 4% of the total number of artificial particles 313, less than or equal to 3% of the total number of artificial particles 313, less than or equal to 2% of the total number of artificial particles 313, or even less than or equal to 1% of the total number of artificial particles 313.

It is noted that the best focus on the artificial particles 313 may not provide the clearest focus on the biological cells 316 or other objects of interest. However, systems and methods described herein provide a consistent focal plane 310 with respect to the bottom surface 304 of the cartridge chamber 302 within the field of view 410, which may provide more consistent imaging. Moreover, moving the focal plane 310 from a fixed offset with respect to the bottom surface 304 of the cartridge chamber 302 may give a clearer view of the biological cells 316 within different layers of the solution 311.

Characteristics of the cartridge chamber 302 may be relevant in determining the focus position 504 of the imaging sensor 124 to capture clear images of the artificial particles 313 and the biological cells 316. Thus, in embodiments, the method for autofocusing the microscopy unit 101 may include determining a tilt level of the cartridge chamber 302 based on the focus curve for each of the artificial particles 313. The tilt level of the cartridge chamber 302 may be determined based on the first field of view 410A, the second field of view 410B, or any number of subsequent fields of view. The method may also include selecting a focus position of the microscopy unit 101 based on the tilt level of the cartridge chamber 302. The selected focus position may bring the most amount of artificial particles 313 within the focus window 502. It should be noted that there may be embodiments where the bottom surface 304 of the cartridge chamber 302 is tilted enough to where it is impossible to get all of the artificial particles 313 within the focus window 502, but the systems and methods described herein maximize the number of artificial particles 313 captured within the focus window 502.

The method of autofocusing the microscopy unit 101 may also include determining the tilt level of the cartridge chamber 302 at corners of the cartridge chamber 302 and then interpolating the tilt level of the cartridge chamber 302 from each of the tilt levels at the corners of the cartridge chamber 302. Referring to FIG. 6, the tilt levels at corners Q1, Q2, Q3, and Q4 of the cartridge chamber 302, corresponding to the first field of view 410A, the second field of view 410B, a third field of view 410C, and a fourth field of view 410D, may be determined separately. Thus, the imaging sensor 124 may capture fields of view 410 for each of the corners Q1, Q2, Q3, and Q4 at the same or different z-positions.

Using the focus curve for each of the artificial particles 313 in each of the corners Q1, Q2, Q3, and Q4, the tilt level of the cartridge chamber 302 at each corner may be determined and the tilt level of the entire cartridge chamber 302 may be interpolated based on the tilt level at each corner. In some embodiments, the first field of view 410A, the second field of view 410B, a third field of view 410C, and a fourth field of view 410D may correspond to corners Q1, Q2, Q3, and Q4 covering less than an entirety of the bottom surface 304 of the cartridge chamber 302.

The method may also include generating a three-dimensional model 700 (depicted in FIG. 7B) of the bottom surface 304 of the cartridge chamber 302 using the focus curves for each of the artificial particles 313 or tilt level of the cartridge chamber 302 for one or more fields of view 410. Referring now to FIG. 7A, focus curves for a first artificial particle 313A, a second artificial particle 313B, a third artificial particle 313C, and a fourth artificial particle 313D within one field of view 410 are depicted. The focus curves are an empirically determined measure of contrast of the artificial particle 313 at various z-positions. The focal planes 310 may be combined to capture 10 micron, 20 micron, 30 micron, 40 micron, or 50 micron focus curves for each of the artificial particles 313 to determine the best z-position focus that yields the highest contrast of each artificial particles 313.

The normalized variance (focus measure) of each of the four artificial particles 313 are plotted against the z-position in microns. The z-position is relative to the best focus of the focus position 504. The valley or bottom point of each focus curve is the best z-position focus of the artificial particle 313. Thus, utilizing the focus curves for each artificial particle 313, a three-dimensional model 700 of the bottom surface 304 of the cartridge chamber 302 for the field of view 410 may be generated, as depicted in FIG. 7B.

Referring now to FIG. 7B, the z-positions of the bottom surface 304 of the cartridge chamber 302 within the field of view 410 are modeled. The darkest portions such as point 304A is at zero microns above the lowest focus point in the focus window 502, while point 304B is at over 2 microns above the lowest focus point in the focus window 502. The three-dimensional model 700 of the bottom surface 304 of the cartridge chamber 302 may assist in choosing a focus position 504 of the microscopy unit 101. It is noted that the three-dimensional model 700 is depicted for a single field of view 410. However, multiple three-dimensional models 700 may be combined to give a three-dimensional model 700 of the entirety of the bottom surface 304 of the cartridge chamber 302.

As noted herein, the microscopy unit 101 may include the imaging sensor 124 and the imaging system 201 communicatively coupled to the imaging sensor 124. The imaging system 201 may include the processor 204 and the non-transitory memory storing computer code which, when executed by the processor 204, cause the processor 204 to image the first field of view 410A of the biological sample 315 with the microscopy unit 101.

The non-transitory memory storing computer code may further cause the processor 204 to detect the artificial particles 313 within the first field of view 410A, where the artificial particles 313 are dispersed within the biological sample 315 that is within the cartridge chamber 302. The non-transitory memory storing computer code may also cause the processor 204 to determine the focus curve for each of the artificial particles 313. The non-transitory memory storing computer code may cause the processor 204 to determine the focus of the microscopy unit 101 based on the focus curves for each of the artificial particles 313 and then image a subsequent field of view, detect the artificial particles 313 in the subsequent field of view, determine the focus curve for each of the artificial particles 313, and determine the focus for at least one subsequent field of view.

The non-transitory memory storing computer code may further cause the processor 204 to determine the tilt level of the cartridge chamber 302 based on the focus curve for each of the artificial particles 313. Specifically, the non-transitory memory storing computer code may cause the processor 204 to determine the tilt level of the cartridge chamber 302 for the first field of view and/or at least one subsequent field of view.

The non-transitory memory storing computer code may also cause the processor 204 to determine the tilt level of the cartridge chamber 302 at the corners Q1, Q2, Q3, and Q4 of the cartridge chamber 302 and interpolate the tilt level of the cartridge chamber 302 from each of the tilt levels at the corners Q1, Q2, Q3, and Q4 of the cartridge chamber 302. The non-transitory memory storing computer code may also cause the processor 204 to generate the three-dimensional model 700 of the bottom surface 304 of the cartridge chamber 302 and select the focus position 504 of the microscopy unit 101.

It should now be understood that embodiments disclosed herein are directed to autofocusing a microscopy unit. By determining a focus curve of artificial particles within a biological sample and a tilt level of the cartridge chamber, clearer and more consistent images of the biological sample may be produced. As such, the embodiments disclosed herein allow for improved biological sample analysis.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for autofocusing a microscopy unit, the method comprising:
imaging a first field of view of a biological sample with the microscopy unit, the biological sample housed within a cartridge chamber inserted into the microscopy unit;
detecting a plurality of artificial particles within the first field of view, the plurality of artificial particles dispersed within the biological sample within the cartridge chamber; and
determining a focus curve for each of the plurality of artificial particles.

2. The method of claim 1, further comprising determining a focus for the first field of view based at least in part on the focus curve for each of the plurality of artificial particles.

3. The method of claim 2, further comprising repeating the aforementioned steps for at least one subsequent field of view.

4. The method of claim 3, wherein:
the biological sample comprises cells that are offset from a bottom surface of the cartridge chamber.

5. The method of claim 1, wherein the focus curve for each of the plurality of artificial particles in each field of view are determined in a single depth of field.

6. The method of claim 5, wherein the single depth of field is greater than 2 microns.

7. The method of claim 1, further comprising determining a tilt level of the cartridge chamber based on the focus curve for each of the plurality of artificial particles.

8. The method of claim 7, further comprising determining the tilt level of the cartridge chamber for the first field of view and at least one subsequent field of view.

9. The method of claim 7, further comprising:
determining the tilt level of the cartridge chamber at corners of the cartridge chamber; and
interpolating the tilt level of the cartridge chamber from each of the tilt levels at the corners of the cartridge chamber.

10. The method of claim 7, further comprising generating a three-dimensional model of a bottom surface of the cartridge chamber.

11. The method of claim 7, further comprising selecting a focus position of the microscopy unit based on the tilt level of the cartridge chamber.

12. The method of claim 1, further comprising determining cellular characteristics of the biological sample within the first field of view.

13. The method of claim 12, further comprising estimating cellular characteristics of cells of the biological sample based on the determined cellular characteristics of the biological sample within the first field of view.

14. A microscopy unit comprising:
an imaging sensor; and
an imaging system communicatively coupled to the imaging sensor, the imaging system comprising a processor and a non-transitory memory storing computer code which, when executed by the processor, cause the processor to:
image a first field of view of a biological sample with the microscopy unit, the biological sample housed within a cartridge chamber inserted into the microscopy unit;
detect a plurality of artificial particles within the first field of view, the plurality of artificial particles dispersed within the biological sample within the cartridge chamber; and
determine a focus curve for each of the plurality of artificial particles.

15. The microscopy unit of claim 14, wherein the non-transitory memory storing computer code further cause the processor to:
determine a focus for the first field of view based at least in part on the focus curve for each of the plurality of artificial particles.

16. The microscopy unit of claim 15, wherein the non-transitory memory storing computer code further cause the processor to:
repeat the aforementioned steps for at least one subsequent field of view.

17. The microscopy unit of claim 14, wherein the focus curve for each of the plurality of artificial particles in each field of view are determined in a single depth of field.

18. The microscopy unit of claim 14, wherein the non-transitory memory storing computer code further cause the processor to:
determine a tilt level of the cartridge chamber based on the focus curve for each of the plurality of artificial particles.

19. The microscopy unit of claim 18, wherein the non-transitory memory storing computer code further cause the processor to:
determine the tilt level of the cartridge chamber for the first field of view and at least one subsequent field of view.

20. The microscopy unit of claim 18, wherein the non-transitory memory storing computer code further cause the processor to:
determine the tilt level of the cartridge chamber at corners of the cartridge chamber; and
interpolate the tilt level of the cartridge chamber from each of the tilt levels at the corners of the cartridge chamber.
